(19) United States
(12) Patent Application Publication
(10) Pub. No.: US 2009/0094447 A1
(43) Pub. Date: Apr. 9, 2009

(54) Universal serial bus flash drive for booting computer and method for loading programs to the flash drive

(76) Inventors: Jyh Chiang Yang, Taoyuan City (TW); GoLong Chang, Kaosiung City (TW)

Correspondence Address: BACON & THOMAS, PLLC, 625 SLATERS LANE, FOURTH FLOOR, ALEXANDRIA, VA, 22314-1176, US

(21) Appl. No.: 11/987,819

(22) Filed: Dec. 5, 2007

(30) Foreign Application Priority Data
Oct. 3, 2007 (TW) 96137108

(51) Int. Cl. G06F 9/00

(52) U.S. Cl. 713/2

(57) ABSTRACT

The present invention relates to a universal serial bus (USB) flash drive loaded with operating system and application programs for booting a computer when plugged into the computer, wherein memory of the flash drive is partitioned as a read-only active area and a writeable data storage area, and the operating system and application programs are stored in the active area; and the operating system is executed unrelated to hardware. The present invention also relates to a method for loading programs to the USB flash drive.

### THE FIELD OF THE INVENTION

The present invention relates to a USB flash drive used for booting a computer, and relates to a method for loading the program, including operating system and application programs, into the flash drive so as to allow the flash drive to boot any different computer (hardware independency).

### PRIOR ARTS

In prior arts, a hard drive is primarily used as an auxiliary storage unit and installed with operating system such as Microsoft® operating system and variety of application programs. However, there are following drawbacks for this structure.
(1) Expensive: The operating system, such as Microsoft® XP operating system (OS), is generally expensive, if compared with other open system, such as Linux®. Sometimes XP OS even occupies a half cost of the computer. The Linux OS is even free.
(2) Waste in hardware resource: A standard XP OS occupies 8 to 15 GB of memory storage. Such large operating system due to poor module structure causes a faster microprocessor and larger memory needed. The software structure of XP OS is large in unnecessary manner as compared with Linux OS.
(3) Slow in power on: Due to large OS and unnecessary programs are executed, it slow in power on.
(4) Bad mobility: Hard drive is heavy and collapsible if compared with flash drive. And the hard drive installed with XP OS can almost be working in the computer that XP OS initially installed, based on the reason that XP OS needs to record hardware identification information when initially installed. Thus the XP could not be transplanted to other machines, i.e., hardware dependency.
(5) Easily hacked: The XP OS is installed in a data area which is writable, and thus it is easily hacked by the third party.

### SUMMARY OF THE INVENTION

Not only considering the rapid growth in storage to cost ratio for USB flash drive in these years, but also the advantage of open system such as Linux, FreeBSD etc in public accessibility, cost-saving, good modularity, good mobility (hardware independency), the inventor of present invention considers a USB flash drive installed with open system is with advantage in overcoming the above five drawbacks. The present invention, arranging a read only area installed with an open system such as Linux, but not limited, and a rewriteable area for data storage, at least possesses the following advantages:
(1) Cost-Saving: Linux OS is public accessible and cost free. One 4 GB USB flash drive is below US$30 in year of 2007, much cheaper than XP OS.
(2) Space-Saving: Linux OS is more delicate, smaller and better modularized as compared with Microsoft® OS. In general, Linux OS occupies about 600 MB, but on the contrary, XP OS occupies 5 to 10 GB in storage.
(3) Faster power-on: Due to small size of Linux OS, the power-on speed is faster than XP.
(4) Good mobility: USB flash drive is nothing to do with damage of reading head as hard drive meets, and therefore USB flash drive is firmer. Moreover, Linux OS is designed as hardware independency, which is different from XP OS. Therefore, USB flash drive with Linux OS is better in mobility than hard drive with XP OS.
(5) Not easily hacked: By installing the Linux OS and application programs in read only area and allocating a writeable area in the USB flash drive for storing data, it prevents from being hacked.

The booting procedure for hard drive installed with XP OS is briefly described as follows. FIG. 1 is a structure diagram showing a hard drive utilized as auxiliary storage unit. A central processing unit (CPU) transfers data/codes from hard drive (HD) to main memory such as SDRAM and executes the data/codes. The data is either sent to an output unit such as a screen or inputted from an input unit such as a keyboard or a mouse. When powered on, there are codes of bootstrap, BIOS and OS running in sequence. The booting procedures are as follows. (1) Powered on: Codes of Previous Operating System Test (POST), i.e., bootstrap, are executed; (2) Codes of BIOS (Basic Input/Output System) codes are executed: Then hard drive is selected as booting device; (3) Codes of OS are loaded from hard drive to main memory and are executed; (4) Application programs are executed if necessary. While the OS is initially installed, register files for hardware configuration of such as display card, network card are made and stored. When OS is loaded to hard drive, the system will check the hardware configuration is matched or not. If not, the OS could not run properly. Therefore, the OS could not run if implanted to other different computer. When computer is powered on, considering 80×86, all bits in code segment register are set to 1, i.e., CS=FFFFH, all bits in an instruction pointer register are set to 0, i.e., IP=0000H, and CPU will jump to address FFF0H, where it stores a jump instruction (JMP) which jumps to an initial address of BIOS code. The BIOS code then executes some testing jobs such as memory testing and keyboard testing. After that, it jumps to upper memory block to check whether it exists codes loaded from ROM of SCSI card. If it exists, then the codes are executed. After that it returns to execute the remaining BIOS. After BIOS finished, it jumps to first sector, 512 bytes, called Master Boot Record (MBR), in the hard drive. The MBR is divided to two portions, wherein the first portion is called a Pre-Boot Area which is 446 bytes, and the second portion is called a Partition Table which is 66 bytes. The Pre-Boot Area is used as an area to check which partition is to be active, so that the system is driven to run OS in that partition.

### PREFERRED EMBODIMENT OF THE PRESENT INVENTION

As shown in FIG. 2, it shows the power-on processes for USB flash memory with Linux OS in the present invention, but not limited to Linux OS, whereby such as Mac OS, Mac OS X, FreeBSD, Plan 9 and Microsoft Windows can also be applied. The power-on processes are as follows.
(1) Turning on power;
(2) Entering BIOS (Basic Input/Output System) and determining to run OS in flash drive;
(3) In MBR of the flash drive, it determines to load Linux OS from the selected partition area in the flash drive to the main memory of computer, and then the Linux OS is executed;
(4) Executing application programs if required;

The Linux OS is more flexible to allow system to install the kernel needed if compared with XP OS. Linux OS does not build register files when initially installed, so it is hardware independent and can be easily planted on different computers. After computer is directed to execute Linux OS as above, the registers of CS, IP, JMP, UMB, MBR, Pre-Boot Area do the same processes as previously mentioned.

Hereinafter, a method for loading Linux OS and application programs to the USB flash drive in the present application is explained. The method sets a partition area of USB flash drive as a read only area where it stores Linux OS, and sets a logical partition area as a data storage area. In the following, it takes 4 G USB flash drive as an example.
(1) Partitioning USB flash drive: Plugging-in a USB flash drive loaded with Linux OS. The USB flash drive is partitioned to a 1 GB first partition area (active area) and a 3 GB logical partition area (logical area). The first partition area is formatted as Windows FAT so as in following step (4) to store Linux operating system and application program. The 3 GB logical partition area is formatted as Linux's ext2 so as to store data;
(2) Preparing a set of Linux OS and storing the code in a compact disk: Downloading Linux OS and application programs (AP) codes, and converting them to read-only codes by LiveCD software. Then copying the codes to a compact disk as backup;
(3) Building booting system files in the first partition area of USB flash drive: Under DOS prompt of Windows, we build a booting system file such as Idlinux.sys in the first partition area of USB flash drive;
(4) Copying all files in Linux files in compact disk to USB flash drive: Under Windows, copying all files in the backup compact disk to the active area of USB flash drive. And, copying all files in the directory of isolinux in the compact disk to the root directory of USB flash drive;
(5) Renaming files: Under Windows, renameing isolinux.cfg and isolinux.bin in the isolinux directory to syslinux,cfg and syslinux.bin, respectively, so that the system file lilinux.sys can recognize these file so as to boot system.

Please note that the first partition (active area) is read only area, so that it prevents from virus and attack of hacker. The Linux OS is more flexible in choosing which module is selected if compared with XP OS.

The inventor of the present invention masterly utilizes LiveCD program such as Knoppix, Slax or Stanix to build Linux OS codes in a compact disk. After copying the codes to the active area of flash drive and renaming the files, the booting procedure for Linux OS becomes more steady and simpler as compared with other conventional Linux OS implantation.

The above embodiment is one of the implementation of the present invention, but the present invention does not limit to this. Any modification, change in the spirit of the present invention should be still regarded as in the scope of the present invention. The present invention claims as below.

### BRIEF DESCRIPTION OF THE DRAWINGS

FIG. 1 shows the hardware structure of conventional hard drive booting system.

FIG. 2 shows the hardware structure of USB flash drive in the present invention.

FIG. 3 is flow chart showing the steps of loading Linux operating system into USB flash drive.

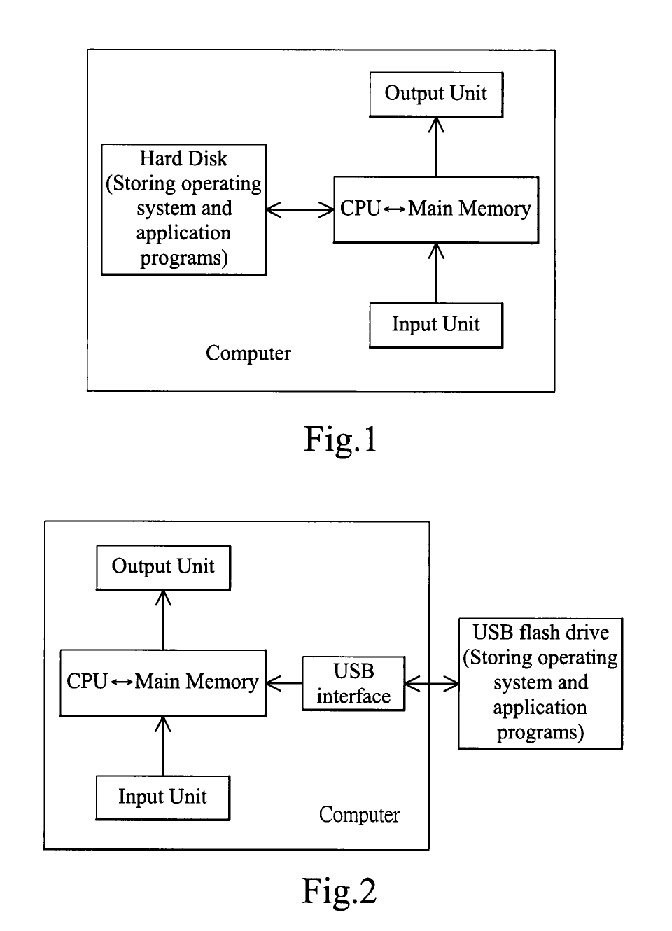

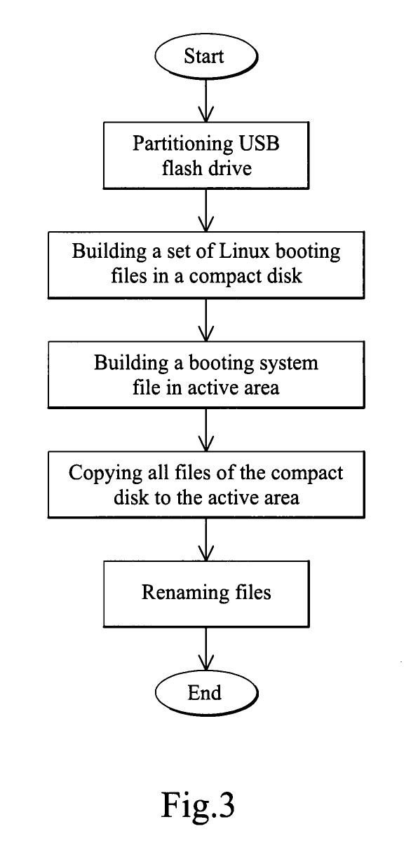

1. A universal serial bus (USB) flash drive loaded with operating system and application programs for booting a computer when plugged into the computer, wherein
memory of the flash drive is partitioned as a read-only active area and a writeable data storage area, and the operating system and application programs are stored in the active area; and
the operating system is executed unrelated to hardware.

2. The universal serial bus flash drive as claimed in claim 1, wherein the operating system is one of the following group consisting of Mac OS, Mac OS X, FreeBSD, Plan 9 and Microsoft Windows.

3. The universal serial bus flash drive as claimed in claim 1, wherein the operating system is flexible in selecting the desire module.

4. A method for loading programs to a universal serial bus flash drive for booting a computer when plugged in the computer, the method comprising the following steps:
(1) partitioning the memory of flash drive as an active area and a data storage area, wherein the operating system and application programs are to be stored in the active area;
(2) building a set of operating system codes and desired application programs as read only codes in a compact disk;
(3) making booting system file in the active area;
(4) storing the operating system codes and the desired application programs in the active area;
(5) copying and renaming the files in the active area so that the booting system file in the active area can recognize and boot the operating system.
